(19) United States
(12) Patent Application Publication
(10) Pub. No.: US 2009/0326917 A1
(43) Pub. Date: Dec. 31, 2009

(54) Computer-Implemented Translation Tool

(76) Inventor: Erich Steven Hegenberger, Karrebaeksminde (DK)

Correspondence Address: HARNESS, DICKEY & PIERCE, P.L.C., P.O. BOX 8910, RESTON, VA, 20195, US

(21) Appl. No.: 12/309,231

(22) PCT Filed: Jul. 17, 2007
(86) PCT No.: PCT/EP2007/057382

§ 371 Date: Apr. 24, 2009

Related U.S. Application Data
(60) Provisional application No. 60/831,206, filed on Jul. 17, 2006.

(30) Foreign Application Priority Data
Jul. 19, 2006 (DK) PA 2006 00997

(51) Int. Cl. G06F 17/28

(52) U.S. Cl. 704/7

(57) ABSTRACT

A computer-implemented language translation tool with a database capable of storing a plurality of source words expressed in a source language and corresponding target words expressed in a target language. The tool generates source concatenations of words expressed in the source language and corresponding target concatenations of words expressed in the target language and stores the concatenations in the database. The database is searched for a match between words of the source text and the source concatenations, and a translation of the words into the target language is proposed in case of a found match. The tool may interact with a user-operated text processing program, in which the proposed translation is presented to the user.

### TECHNICAL FIELD

The present invention relates to a computer-implemented translation tool allowing for automated or semi-automated translation of text in a source language into text in a target language. The tool allows for sustained maintenance of a database forming part of the tool. Preferred embodiments of the invention rely on syntax-based recognition of text strings.

### BACKGROUND OF THE INVENTION

Products known on the translation tools market include machine translation, terminology databases, and translation memory programs. Machine translation programs, which attempt to use various heuristic algorithms and dictionaries containing grammatical rules to arrive at a translation with no human input, will not be further discussed here other than to observe that, at the current state of development, their results are not yet suitable for most practical purposes.

Terminology databases typically include keyed pairs or groups of words in the source and target languages. They vary from simple one-to-one lists of source and target words and/or phrases to full-blown databases with elaborate searching, filtering, editing and annotating functions, including automatic term lookup and replacement controlled directly by mouse click or hotkeys from standard word-processing applications.

More complex but potentially useful is what is known as ‘translation memory’ databases, which store entire source/target phrases or sentences in pairs for subsequent retrieval by semi-automated lookup, initiated either from the working document in a word processing application or from within the translation memory interface. Semi-automated generation of translation memory entries is also possible in a process known as “alignment”, generally performed on a pair of source/target documents from a previous translation. These translation pairs can be created, searched, filtered, edited, deleted, imported, exported, annotated and shared among translators, e.g. in an industry-standard format such as TMX. Each new document is processed by searching the database for matches or near matches, and the user is prompted with the best results, if any, as a possible translation. The final translation of the sentence is stored in the database with its source as a new entry.

“Fuzzy” searching as well as attempted merging of translation segments with each other and with entries from terminology databases is also known. Some such programs also enable further analysis of prior translations to “extract” or “mine” for individual terminology entries. Although extremely useful on an everyday basis, terminology databases still require that the user performs the necessary steps to search for and use terms in a document and to make new entries in the database. They also do not encompass all of the translator's work, but rather are generally only limited to industry-specific terminology within a specific branch.

One drawback of translation memory as known is that, unless the scope of documents translated is extremely narrow, it may be years before a sufficiently large database has been generated to provide an occasional hit.

Furthermore, even semiautomated processing is so time-consuming that any advantages in speed or repeatability are often lost in cumbersome operation and database maintenance or project processing. Even if a terminology database has been generated by semi-automated alignment, in the end the individual user still has to manually examine the individual entries for correctness before entering them in a translation document.

Also, the most common interface for displaying and editing translation memory information remains largely unchanged from its initial layout of some two decades ago. Translators who may only be marginally computer-literate and are used to overtyping a document are constrained work in a single specific way in an interface that is less than intuitive to the uninitiated, and which may or may not be ideally suited to the work at hand. Instead of allowing translators to work unencumbered, some current tools even require that a translation document be first imported into the actual translation memory program before processing can proceed in an interface which is often completely foreign to translators.

In addition, most translation memory programs only store the entire sentence and can thus only attempt to tap the wealth of translation information provided by the user by employing complex “fuzzy algorithms” which look for the entire sentence most closely matching the sentence of interest, then either trying to fill in the blanks or leaving them for the user. The result, even from a “close fuzzy match”, may have no bearing on the translation task at hand.

Another drawback of most translation memory programs, despite the advertised time savings, lies in accounting for the fact that a proofreader or translation customer will frequently return a corrected version of a translation to the original translator with alternate terminology and/or phrasing. To provide the best service to repeat customers, this Information must be entered into the database, which can be an extremely laborious task unless the proofreader or customer corrects the document using the same translation memory tool as the original translator.

### SUMMARY OF THE INVENTION

It is an object of preferred embodiments of the invention to provide a translation tool, which overcomes at least some of the above disadvantages. More specifically, it is an object of preferred embodiments of the invention to provide a flexible, adaptive tool relying on a database which tracks, as automatically as possible, the changes a user makes to a document in the translation process. It is a further object of preferred embodiments of the invention to provide a tool which is as invisible as possible to the human user, making its presence discretely known only when it can actually be of service, and requiring as little direct attention from the user as possible to develop a complete database of useful information with immediate benefits to the user in speed and accuracy. An overall object of preferred embodiments of the invention may thus be seen as to enable human translators to improve their productivity, accuracy and consistency by providing them with a natural, intuitive, nonintrusive, effective interface with their electronic information.

In one aspect, the invention provides a computer-implemented translation tool, comprising:
a database module capable of storing, in a database, a plurality of source words expressed in a source language and corresponding target words expressed in a target language;
a concatenation module for generating source concatenations of said words expressed in the source language and corresponding target concatenations of said words expressed in the target language, and for storing said concatenations in the database;
an input module for receiving a source text in said source language;
a translation module programmed to, upon occurrence of a predefined event, search the database for a match between a word or a sequence of words of the source text and said source words or said source concatenations, and to propose at least one translation of said word or sequence into the target language in case of a found match, the at least one translation being provided as that one or those of the target words or the target concatenations, which corresponds to the matching source word or source concatenation.

As used herein, the term “translation tool” may designate a “translation system”, such as a system comprising appropriately programmed computer hardware. It should be understood that the modules of the present invention do not necessarily appear as separate modules to a user of the translation tool. A “module” should merely be understood to comprise any part of a computer or computer system, on which the invention is implemented, instructed to perform the various actions as disclosed herein.

The invention also provides a computer-implemented method for facilitating translation from one language into another. The method comprises the steps of:
storing, in a database, a plurality of source words expressed in a source language and corresponding target words expressed in a target language;
generating source concatenations of said words expressed in the source language and corresponding target concatenations of said words expressed in the target language, and storing said concatenations in the database;
providing a source text in said source language;
upon occurrence of a predefined event, searching the database for a match between a word or a sequence of words of the source text and said source words or said source concatenations, and proposing at least one translation of said word or sequence into the target language in case of a found match, the at least one translation being provided as that one or those of the target words or the target concatenations, which corresponds to the matching source word or source concatenation.

The step of storing may be performed by means of a database module of the computer system. The steps of generating and storing said concatenations may be performed by means of a concatenation module of the computer system. The source text may be received by means of an input module of the computer system. A translation module may be provided to perform the steps of searching the database and proposing the at least one translation.

### DETAILED DESCRIPTION OF EMBODIMENTS OF THE INVENTION

The below description includes explanations and features, which are provided by way of example only, and which are not limiting on the scope of the appended claims.

The translation module is accordingly capable of matching words or sentences typed in a source text with corresponding words or sentences in a target language. However, a user of the translation tool may control the tool's interaction with the interface, in which the user is typing, such as the user's word processing system. Preferably, the translation tool performs “on-the-fly” auto-recognition of typed text as the user types along, but it only displays proposed translations of words of sequences of words in response to the predefined event, e.g. a predefined user interaction. The user may for example type the following text in English in a word processing system:

I hereby reply to your letter dated 22 Jun. 2006.

In response to a predefined user-interaction, e.g. a predefined combination of keys being pressed simultaneously by the user, e.g. CTRL-SHFT-F2, when the cursor of the text processing system is at the beginning of the sentence, the translation tool may activate and show the following translation options into German:

I hereby reply to your letter dated 22 Jun. 2006
Option 1: Ich beantworte hiermit 1 hr Schreiben vom 22. Juni 2006
Option 2: Ich beantworte hiermit Dein Schreiben vom 22. Juni 2006
I hereby reply
Ich beantworte hiermit
to your letter

### Option 1: zu Ihrem Schreiben

### Option 2: zu Deinem Schreiben

dated 22 Jun. 2006

### vom 22. Juni 2006

### I

### Ich

hereby
hiermit
reply

### Antwort

beantworten
beantworte
etc.

The complete translated sentence (if available as in the above example) and the available individual words and sub-sequences stored in the database are preferably shown in a list, from which the user may select the desired translation, sub-translation or sub-translations. The translation tool may allow the user to enter a new entry to the database, allowing the user to translate himself, e.g. if no one of the proposed alternatives is acceptable to the user.

Preferably, the translation tool only proposes one or more possible translations, if the database contains appropriate, i.e. meaningful entries. If no such entries are found, i.e. if no match between source and target language is found the database, the tool may simply provide no response or, alternatively, an input mask for the user to enter a new translation.

The translation module is preferably programmed to interact with a text processing program operated by a user of the translation tool. For easy adaptation of the translation(s) in the user's working document in the text processing program, the translation module may be programmed to enter a user-selected one of the at least one translation into a working document in the text processing program. The translation or translations presented to the user may conveniently be presented to the user in an interface in the text processing program. The interface may contain a list of source words or sequences of source words and corresponding target words or sequences of target words presented, e.g., in a left-hand and a right-hand side of the list. Alternatively, only the target words and sequences may be presented, the presented target words or sequences corresponding to a word or a sequence of words highlighted in the source text in the text processing program.

In embodiments, in which the translation tool interacts with a text processing program having a user-operable insertion marker, the predefined event mentioned above may be recognized as the presence of the insertion marker at a single location in the source text for a predetermined period of time. For example, if a cursor of the text processing program has remained in the same location for at least five seconds, the translation tool may activate the translation module.

The translation module may also be programmed to show a plurality of lists of possible translations of words of the source text in the text processing program, there being provided one list adjacent to each word in the source text. Accordingly, a plurality of “mini lists” may be provided, essentially enabling drag-and-drop translation.

In a preferred embodiment, the translation tool prompts the user as automatically as possible to repeat changes performed in the past, when it recognizes the potential for a repeated action. The user may be provided with choice, e.g. with a single keystroke, to accept a proposed translation word, phrase, or sentence, or to ignore the computer's suggestion and continue with a new translation, which is also recorded for future reference, with no limit to the number of translation targets which can be stored for a given source.

It will be appreciated that preferred embodiments of the translation tool according to the invention may feature intuitive simplicity of use, as well as a database which quickly fills with usable information in an automatic or nearly automatic manner. Few tedious, repetitive keystrokes are required, and automatic generation of translation suggestions based on available database entries is provided. The translation tool may optionally include an automatic spell checking of new entries. Communication with the user is preferably performed through a nonintrusive interface window which automatically positions itself close to the text directly in the translator's editing application, and which is either displayed automatically or is activated and controlled by the minimum possible number of keystrokes. As an alternative, individual database entries may be presented in multiple dialog boxes adjacent to the corresponding words or phrases in the source text. As a further alternative, translation memory segments may be collected completely in the background, whereby the tool ‘looks over the user's shoulder’ and automatically detects new source/target language segment pairs as the translator works, optionally marking up the source document with industry-standard translation memory tags in the process, without the tool prompting the user for inputs or otherwise making its presence known. Any interface may also optionally be configured to automatically prompt the user only if it has useful translation information to offer, otherwise remaining in the background. Automated or semi-automated incorporation of subsequent proofreading/feedback corrections in the database may be provided for.

The translation tool may allow editing of existing database entries, such as by replacement or addition of existing entries, and may optionally prompt the user for confirmation prior to storing of the corrections in the database.

As it will have become apparent from the above discussion, the translation module may further be programmed to:
decompose said sequence of words of the source text into a plurality of sub-sequences;
search the database for matches between each of the sub-sequences and source concatenations of the database;
propose a sub-translation in respect of each sub-sequence, each sub-translation being provided as the target concatenation corresponding to the matching source concatenation.

The sub-sequences may constitute different linear concatenations of individual words of the sequence of words of the source text, whereby the sub-sequences include different numbers of words.

The translation module may be programmed to present the sub-translations in a prioritized order to a user of the translation tool according to at least one of:
length of the subsequences;
most frequently selected sub-translation;
order of appearance in the source text.

The tool may determine frequency of use as overall frequency or as recent frequency of use, e.g. taking into account only the past 20 translations (user selections).

Further, the translation module may be programmed to:
decompose said sequence of words of the source text into a plurality of words;
search the database for matches between each of the words of said sequence and source words stored in the database;
propose a translation of each word of the sequence, the translation being provided as the target word which corresponds to the matching source word.

The translation module may be programmed to automatically generate concatenations of words of the source text and to search the database for matches between said sequences and said source concatenations. The concatenation module may be programmed to generate a plurality of target concatenations of the concatenations of the database.

User-provided translations of sequences of the source text may be received by the translation tool and stored in the database. In one embodiment, all possible linear concatenations of the words and sub-sequences in the user-provided translations may be stored in the source language and in the target language.

In one embodiment the translation module is further programmed to recognize a change of syntax between the sequence of words of the source text and the target concatenations, and to store, in the database, a target concatenation of words, which corresponds to the changed syntax of the source text.

The translation module may further be programmed to:
decompose the sequence of words of the source text into a plurality of sub-sequences; and
in case no sub-translation of one of said sub-sequences is found as a target concatenation in the database: split at least one of the sub-sequences into a first and a second fragment, and to search the database for target concatenations matching said fragments; and
in case the fragments match concatenations or words in the target language: concatenate the corresponding target fragments into a new database entry.

The steps of decomposing, splitting, concatenating and storing may be performed without user interaction.

The translation module may be programmed to activate a dictionary-look-up module following pre-defined user-interaction, allowing retrieval of translations of words or phrases of source text into the target language.

The translation module may be programmed to recognize a word or plurality of words of the source text as an initial fragment of a concatenation of words stored in the database and to autocomplete a translation of said concatenation into the target language. For example, an initial part of a standard phrase like: “I hope that the above” may be auto-recognized as “I hope that the above comments answer your questions. Please do not hesitate to contact me if I can be of any further assistance” and completed in the target language.

As mentioned above, the translation module may programmed to, upon translation of a text string into the target language by the translation module, allow user-initiated corrections to the text string of the target language, and to store said corrections in the database.

The database may be capable of storing a plurality of target words or target concatenations matching one source word or one source concatenation, and the translation module may be programmed to propose a plurality of translations in respect of one single source word or source concatenation, in which case the translation module may further be programmed to list said plurality of translations according to their frequency of use.

The predefined event initiating translation may e.g. include user-initiated highlighting of a word or a sequence of words of the source text. For example, the translation module may be programmed to show only a translation of that word or sentence highlighted by the user.

As discussed above, the translation module is preferably programmed to interact with a text processing program operated by a user of the translation tool. In this case, the translation module may further be programmed to perform background markup of a working document of the text processing program with translation memory tags, e.g. industry-standard translation memory tags.

The translation module may further be programmed to store words or sequences of words in the database manually translated by the user and typed in the text processing program. In other words, the translation module may perform background storage (without display of the suggestion interface) of database entries as the user works.

A user-correction interface may be provided, allowing a user of the translation tool to correct the translations stored in the database. The tool may be programmed to prompt the user for confirmation of a correction prior to storage thereof in the database.

The translation module is programmed to store corrections as new database entries without deleting previous entries.

In one embodiment, the translation module is programmed, on detection of the user having opened in a text processing program a document containing corrections or changes to a previous translation for which entries were stored in the database, to sequentially display each such correction to the user for approval and to store said changes in the database. The changes may be stored in the database without user approval of each individual change. The changes to database entries may include changes to database entries containing elements not stored during translation of the original of said document but for which said document contains corrections or changes. For example, if a corrected document is received for which the translation of ‘Küche’ is changed from ‘kitchen’ to ‘cuisine’, all database entries containing the word ‘Kuche’ may be changed accordingly.

The tool may be programmed to search a file system of the computer, onto which the tool is installed, for documents containing corrected translations or translations not stored in the database, and to store said translations in the database. User-confirmation of new or corrected database entries may be prompted for by the tool.

The translations or translations not stored may be stored in the database as new database entries without deleting previous entries. The translation module may be programmed, on detection of a document containing corrections or changes to a previous translation for which entries were stored in the database, to sequentially display each such correction to the user for approval and to store said changes in the database. The changes in the database may be stored without user approval of each individual change. The changes to database entries may include changes to database entries containing elements not stored during translation of the original of said document but for which said document contains corrections or changes. It will hence be appreciated that an embodiment of the tool may automatically (a) detect the presence of a file that has been changed, (b) find and correct or append the corresponding database entries and (c) find and correct or append any other entries containing the same words.

Generally, the translation tool may include an intuitive interface module for displaying translation source and target information from the database for user action.

A list may be provided in which the user can select, edit, enter or delete a translation, using intuitive key combinations based on word-processing to navigate the list.

Once displayed, a target translation can be edited with no other input than by typing, and accepted for continued processing by pressing Enter.

The translation tool may be adapted to perform assignment of hotkeys for “translation” of a word or phrase as a blank or as a direct copy of the source and continued processing with no further user action.

The user may also have the option of extending (or shortening) the selected source sentence in the working document by holding down Alt and pressing the left/right arrow keys.

The translation tool may feature listing of sources with stored target translations in an intuitive order, including stored translations for linear concatenations of source words and computer-generated suggestions.

The list of sources and targets may be positioned close to but not covering the source text in the working document.

In order to account for syntax changes in the displayed list, the tool may offer the next word or phrase after the word or phrase just translated as the first choice for the user's next action.

To account for combined word forms, the tool may, given translations for two or more separate words which appear combined in a single word in the source, with or without connectors from a user-definable list, suggest the translations for those words in sequence as a translation for the combined word.

Selected source text may be highlighted. As the user moves down the list, optional highlighting of the selected source words with optional elimination of the source side of the aforementioned list may be provided for.

An optional display of lists of target phrases and words adjacent to each source word in the current sentence in the working document may be provided.

Replacement of source words with formatting different from the surrounding text with targets in the same formatting.

To account for singular/plural, verb forms and capitalization variants, the tool may check for these, and translations may be provided for words with similar root forms and with or without capitalization or alternate endings supplied in a user-editable list.

As a user-selectable option, the tool may provide for background storage and extraction of data from translation work. The user can select to deactivate the pop-up display window and, with or without automatic insertion of translation memory markup tags in the working document, perform translation work “unaided” by overtyping the source document with the translation. If background processing is selected, the program may save each completed sentence as a source/target translation pair in the database, and may further analyze the stored sentences based on current database contents to extract any useful terminology from the new sentences. Optional automatic insertion of markup tags in the working document may be possible here as well.

In addition to background storage and terminology extraction, the program may also have a user-selectable “automatic suggestion” mode. This function is similar to that of “autocompletion” programs, where the popup window with list of translations is only displayed if the program has a matching translation for a text string starting at the current insertion point in the working document. The user can choose to accept the suggested translation, to edit or delete it as described above, or can press the Esc key and continue “unaided” translation work.

Automatic continuation of processing at the next sentence, table cell or other translatable text in the working document.

Automatic scrolling of working document may be allowed for to keep current text within display limits.

The program may also be capable of recognizing industry standard translation memory markup tags (‘{0> . . . <}’ etc.) and taking appropriate action whether they are displayed or hidden. On encountering tagged translation pairs in a document where the source and target are identical (i.e. no prior translation has taken place) and translation memory markup tags are hidden in the display, processing as described here is unchanged, but the user may, if he chooses, use hotkeys to display the translation pairs for editing as they would appear in any “standard” translation memory program, with appropriate highlighting of the source and target. The tool's window with translation listings may then be displayed at the highlighted target for normal processing, but may be deactivated for processing as in industry-standard translation memory programs. On completion of a sentence, tagged translation pairs may again be displayed as normal text with the source and tags hidden and the translation visible, and processing may continue to the next sentence.

If tagged translation pairs are encountered in a document where the source and target are not identical (i.e. the document has been pretranslated) and translation memory markup tags are hidden in the display, the program may automatically display these pairs for editing as they would appear in any “standard” translation memory program, with appropriate highlighting. For translation memory pairs which have already been translated and only require checking or minor corrections, the user can use hot keys to optionally deactivate the program's normal listing and highlighting functions (if activated) and to edit and accept the translation pairs. On completion of a sentence, tagged translation pairs are again displayed as normal text with the source and tags hidden and the translation visible, and processing continues to the next sentence.

The user may also be allowed to select optional markup of a document using industry-standard tags, no matter what other program features are active. If this option is selected, each time translation of a sentence is completed, the complete source and target sentences are automatically marked and stored in the document.

The tool according to the present invention may provide for automated or semiautomated processing of translation feedback or corrections in the database, including making changes to translation database entries with the same terminology but not used in the corrected translation, with automated or semiautomated storage of time stamp and reference information for each entry. In this way, if the user has previously translated a document using the tool and subsequently makes or receives corrections to that document, he can open it and have the tool automatically replace or supplement all of the database entries corresponding to changes in the document. As a further option, the tool can also replace or supplement all database entries with corresponding terminology change requirements. For example, if the user has previously translated “Die Küche war hervorragend” as “The kitchen was protruding” and receives the translated document back from a customer with the correction “The cuisine was outstanding”, and depending on which option the user selects, the tool can either replace the database entries for “Die Küche war hervorragend”, “Die Küche war”, “Die Küche”, “Küche war hervorragend”, “Küche war”, “Küche”, “war hervorragend” and “hervorragend” with the corresponding corrections, or can supplement the database with additional targets for these source entries, including time stamp and (for example) customer information, and, as a further option, can also replace or supplement all other entries in the entire database containing the words “Küche” or “hervorragend”. The user has the option of examining these entries one at a time for approval of changes or supplements or can have the tool automatically process all corresponding entries for the working document.

If selected as an option, the tool according to the present invention may also regularly examine selected directories on the user's computer for updates to previously processed documents and prompt the user for automatic processing of any corrections as described above.

A fast processing mode may be provided as a user-selectable option. If there is only one database entry for a word or phrase (in each case the longest available concatenation of words is taken), the translation tool may be programmed to automatically insert the corresponding entry and proceed to the next word or phrase.

As a further option, there may be provided optional translation processing and list display on leaving the insertion point at the same location for a user-selectable delay period.

Further, user-configurable popup context-sensitive menus/help may be provided: on pressing the Alt key, the program first accepts input from a second hotkey to perform a desired action (such as Alt-right arrow to extend the selected sentence). If a second key is not pressed within a user-configurable delay period, the program displays a user-selectable list of actions most frequently used, followed by the full list of possible actions after a second user-selectable delay time.

Optional color coding of list entries, such as for unsubstantiated or confirmed terminology, or computer-generated entries from statistical parsing of previous translation work may be provided.

The user may have the option of selecting automatic capitalization at the start of each line or sentence, as well as automatic capitalization at the start of each table cell. The user may also be allowed to optionally select automatic detection and capitalization of titles and section headings where possible.

As a user option, the tool may be programmed to attempt to account for mixed formatting in concatenated entries. For example, given the source sentence “Die Katze maunzt”, even if the translation “The cat meows” already exists in the database, the program may look for a translation of the individual word “Katze”, and, if found, use this with the full-sentence translation to compose a suggestion with the appropriate formatting, in this case, “The cat meows”.

As a user-selectable option, the program may also provide a simple autotype/autocompletion function, drawing on the database, for use such as when editing a document or creating a new database entry.

As a user-selectable option, the program may also provide for on-the-fly spell checking of target entries before acceptance for insertion in the working document and storage in the database. This requires the installation of a dictionary in the target language.

As a user-selectable option, the tool according to the present invention may also provide for semiautomated project processing. If selected, and when a user starts working with a new document for the first time, the program prompts the user for project, customer and subject information for storage with each database entry associated with this document.

One embodiment of a functionally complete implementation may have the following characteristics/features:

A separate executable database program which interfaces with Microsoft Word and/or other word-processing/office applications. Any suitable database tools and programming language may be used provided execution is sufficiently fast on a typical current office PC. One application may be implemented in C# using the Microsoft .Net Framework version 2.

Use of API/COM features to obtain information on the user's working document from its parent application.

The tool may rely on database storage and retrieval of individual words and phrases as well as syntactically linear concatenations of the same. What is meant here is that preferred embodiments of the tool should not store as individual translation segments groups of words in an order which does not appear in the source text. The tool may then present the user with as much useful information as possible, as quickly as possible, and may also enable the user to navigate and select between a large number of options with as few keystrokes/mouse clicks as absolutely necessary. No matter what final form the interface takes, emphasis should be placed on clarity and intuitive simplicity of use.

(Note: While recalling that one overall object of preferred embodiments of this invention is to provide translators with the an intuitive and simple-to-use translation tool, it may be convenient or enlightening for the purpose of understanding the programming task to regard the actual process, especially as regards commas and other difficult items, as a nonlinear ‘mapping’ of discrete elements or combinations of same into other discrete elements or combinations, where these elements just happen to comprise words, punctuation, phrases and sentences in the source and target languages. These elements may be displayed in a clearly understandable form, starting with those the user is most likely to select, with all possible elements selectable using the fewest possible keystrokes.)

Detection of words and groups of words in the working document starting from the current editing location, and display of these words in a scrollable list for selection and editing. In the most simple form, the list may include source words on the left and target words (or blanks if untranslated) on the right.

Provision for editing of target translations (right-hand side of translation list):

a) Simply by typing to replace any previous displayed entry for the selected source
b) By pressing F2; this should move the selection point to the end of any currently displayed target for the selected source
c) By slowly clicking twice on the target; same response as for F2.

Provision for user selection of a translation by pressing return or double-clicking. This operation should replace the selected source string with the selected target string in the working document and store or update the source-target pair in the database.

Provision for deletion of displayed entries, e.g. by right-clicking and selecting ‘Delete entry’ from a pop-up menu.

Provision of hot keys such as Alt-x, Alt-c for “translation” of a word or phrase as a blank or as a direct copy of the source.

Provision for user annotation of an entry with reference information as well as with filterable information such as user, customer, project, document, subject, date, and entry confidence/reliability, with storage of this information with the entries in the database.

### Provision for User Navigation in List:

a) By pressing up/down or left/right arrows to move between adjacent list entries
b) By holding down Ctrl and repeatedly pressing the starting letter of the desired target string to jump to corresponding target entries
c) By holding down Ctrl and pressing the left/right arrows to move between adjacent source words or phrases (corresponds roughly to Ctrl-arrow keys in word processing programs)
d) By holding down Ctrl and Shift and pressing the left/right arrows to extend/shorten the selected source phrase (corresponds roughly to Ctrl-Shift-arrow keys in word processing programs).

Provision for the user extending (or shortening) the current source sentence in the working document by holding down Alt and pressing the left/right arrow keys. This feature allows the program to account for mid-sentence abbreviations such as “etc.” or other instances where the source does not necessarily end with the first terminator, or to include other special characters such as tabs or carriage returns in the source. If a word followed by a period is stored in the database and appears in the text, the tool may assume that it is a mid-sentence abbreviation and continue on to the next period or other terminator to define the working sentence, displaying the word together with the period as a single word in the list. If the user encounters a new abbreviation that is not stored in the database, he may be able to use the Alt-right arrow key to force processing past the abbreviation, and if a sentence ends with an abbreviation and the program inadvertently proceeds beyond it, the user can use the Alt-left arrow key to shorten the selected sentence accordingly.

An undo function (can also be an Alt- or right-click menu option) may also be provided for the user to selectably undo the last entry, the last n entries where n is a selectable number up to e.g. 9, or all entries back to the start of the current sentence (or the last sentence if processing of the current sentence has not yet been started). This function may undo all changes made to the database back to that point, as well as all changes made to the working document back to that point. Restoration of the insertion point location is not necessary.

This extension/shortening of the selected source may entail reprocessing of the new extended sentence.

Accounting for syntax changes: Given string of words “AA BB CC DD”, if the user starts translating at word CC by scrolling to that word in the list and selecting a translation, the tool may remove that source word from the working document and insert the selected translation at the current insertion point. When processing continues, the tool may then offer the next word (DD in this case) first or scroll to its position in the list before returning to the “front of the sentence” (words M and BB). The user may be free to select any of the words or phrases offered in the list for translation in the desired order.

User-definable terminators such as .!? for special handling.

User-definable separators such as !@$%&*( )+ [symbol] £″′/\;:,=[ ]{ } for special handling.

After the user accepts a translation, the insertion point may move to the start of the next word, not the end of the last word. Or, if in a table, processing may continue in the next table cell, etc.

Care may be taken to ensure that the last word before a full stop as the last character in a table cell is also ‘detected’. Also, when inside tables, end of cell (asci 13, 7) may not be displayed for translation. Processing should continue to next cell or line or whatever comes next.

List navigation may include pageup/down and home/end keys.

Even after editing in the right column has started, the user may be able to change his mind and continue up or down to a different entry by hitting Ctrl-letter or an up/down arrow, without first hitting escape.

Provision may be made for exiting processing by pressing the Esc key or switching to another program window by keyboard or mouse input, hiding the suggestion window and returning the program to the background.

Sources may be presented with stored target translations starting with the first word in the source and in order of decreasing length. For example, given the source sentence ‘The cat meows’ which has previously been translated one word at a time, the list may display ‘The cat meows’ first, followed by ‘The cat’, followed by ‘The’). Groups of words for which no translation is available may not initially be displayed; i.e. if there were no translation for ‘The cat’ or ‘The cat meows’, these source entries may not initially be listed, but the individual words may always be listed, with a blank if no translation is currently available. Note, however, that if the user selects a group of source words for which no current translation is available by pressing the Ctrl-Shift-arrow keys, the program may list this new source for translation and acceptance.

These entries may be followed by the set of sources with stored target translations starting with the next word in the source and in order of decreasing length. For the above example, the next entries in the list would be ‘cat meows’ and then ‘cat’.

Processing in this way may continue until all possible linear concatenations of source words (in the order in which they appear in the source) have been listed; for the above example, the next and final source entry in the list would be ‘meows’. Provided there are translations available in the database for all of the possible linear concatenations of source words in this example sentence, the displayed list of source words and translations would thus be as follows:

Die Katze maunzt.

| | |
|---|---|
| The cat meows | Die Katze maunzt |
| The cat | Die Katze |
| The | Die |
| cat meows | Katze maunzt |
| cat | Katze |
| meows | maunzt |

As a user-selectable option, the tool may also display a linear concatenation of the most frequently used translations for the longest respective source segments as a suggested translation. For the above example, if the database contains approved translations for “The cat” and “meows” in addition to translations for the individual words, but no translation for the full sentence “The cat meows”, the tool may offer the concatenation of the translations for “The cat” & “meows”, but not for “The” & “cat” & “meows”, as a suggested translation, thusly:

Die Katze maunzt.

| | |
|---|---|
| The cat meows | Die Katze maunzt |
| The cat | Die Katze |
| The | Die |
| cat meows | Katze maunzt |
| cat | Katze |
| meows | maunzt |

This computer-generated suggested translation may be designated as such by an alternate format or color so that the user does not mistake it for an already approved, stored translation from the database. The location of this translation suggestion in the list may be user-selectable, and the user may also have the choice of having the window open with this suggestion or the longest stored database entry highlighted for fast selection.

If a translation for a word or phrase is already in the database, and if the tool comes up with the same translation, this should preferably not be displayed as a suggestion. In this case no suggestion should be displayed; only the actual database entry.

For each source with multiple targets, these targets may all be listed in order of decreasing recent frequency of use. For example, if the word ‘The’ in the above example had been translated with ‘Der’, ‘Die’ and ‘Das’, with ‘Die’ being the translation most frequently used in the recent past, the first translation listed for ‘The’ would be ‘Der’. If the next most frequently used translation were ‘Die’ and the least-frequently used translation ‘Das’, this portion of the list would appear as follows:

| | |
|---|---|
| The | Der |
| The | Die |
| The | Das |

This necessitates calculation of a user-adjustable weighted average of recent frequency of use, with storage of this frequency value in the database. Given a selection of different translations for a word, if the user selects a specific translation more than n (a user-selectable number) times in a row, it should preferably percolate to the top of the list. This could be done, for example, by adding 1/n to the frequency value for the selected translation and then dividing all possible translations by 1+1/n.

Provision may be made for optional presentation of this frequency information to the user.

The list of sources and targets may be positioned close to but not covering the source text in the working document, and may be resizable by the user.

Accounting for syntax changes when displaying list: Given the string of words “Ich habe das schon getan” to be translated as “I have already done that”, if the user selects “Ich”, then “habe”, then “schon” for translation, the program may automatically scroll to the word “getan” in the list on the next round, anticipating further translation from that point. On reaching punctuation, however, the program may return to the first remaining word to be translated in the sentence.

In accounting for syntax changes, the original syntax may be ‘remembered’ in some way when words are being plucked out from further on in the sentence. For example, given AA BB CC DD EE with translation cc dd aa bb ee, the tool will ‘see’ AA BB DD EE after the first word is translated, AA BB EE after the second, etc., while aa bb ee is probably not a valid translation for AA BB EE. In this case, the tool should store, in addition to the translations for the individual words, entries for CC DD, AA BB, AA BB CC DD, and AA BB CC DD EE, but not BB CC DD etc.

User-selectable option of accounting for combined word forms, e.g. given the translation “cup” for “Tasse” and “coffee” for “Kaffe”, the program may automatically suggest “coffee cup” as a possible translation for “Kaffe*Tasse”, where * stands for no space or any of a list of connectors such as -, n, s, en, es etc. which the user can supply in a list in the options menu. This is not limited to only two combined words, for example, if the program encounters the word “Vierwaldstaetterseedampfschifffahrtsgesellschaft” and already has translations for the words “Vlerwaldstaettersee”, “Dampf” “Schiffahrt” and “Gesellschaft” but not for any combinations of these, it may suggest a translation for the entire combined word.

Highlighting of selected source—as a user-selectable option, as the user moves down the list, the selected source words may be optionally highlighted (using industry-standard or user-selectable background colors). This enables the user to focus on the task at hand in long sentences, and where source words are repeated within the same sentence, to make sure the right one has been selected. With this feature activated, the left-hand column displaying the source words in the list is redundant and may therefore also be optional.

As an alternative to the single list of translations, the program may be capable of displaying lists of target phrases and words adjacent to each source word in the current sentence in the working document. Each list may contain only those linear concatenations of words starting with the adjacent source word. The list starting with the first word at the insertion point may be fully visible, while the others will be partially obscured and may be brought to the front by using the Ctrl-arrow keys described above or by hovering with the mouse. The user may generate the target translation by selecting the desired translation words in the desired sequence from the respective lists in the same way as described above.

### Example

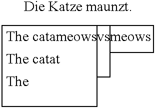

For this particular example, the user would select only the first provided translation in the first visible list. However, if the complete translation had not already been entered in the database and translations were only available for the individual words, the display would appear as follows:

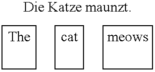

The edges of the translation list box should preferably not pass beyond the edges of the display:

a. If the list is shorter than the display box, the bottom of the box should move up to the bottom of the list. This should be temporary, i.e. box height should return to the last user-selected size for longer lists.
b. Top of list box should start below end of sentence (remember that sentence may cover more than one line) or bottom of box above start of sentence.
c. List box should not extend beyond display borders. Correct as follows:
i. If too far to the right, the entire box should be shifted left until the right edge is at the edge of the display. If this places the left edge outside of the display, the box should be resized to fit within the display.
ii. If the top of the sentence is above the bottom ¼ of the screen, the box should be resized to fit.
iii. If the top of the sentence being processed is in the bottom ¼ of the screen, the box should be positioned with the bottom edge above the top of the sentence and then resized to fit if necessary.
iv. If the top of the sentence being processed is in the bottom ⅛ of the screen, the document may be scrolled down until the sentence being processed starts at the top ¼ of the screen and the box then resized to fit if necessary.
v. It should preferably also be ensured that the box is at all visible—sometimes, especially towards the end of a document, the box may apparently be displayed somewhere below the screen limits.
vi. In all cases, the box should be placed as close to the current insertion point as is reasonably possible.

The program may use wildcards in the database as ‘placeholders’ to account for nontranslatable inline objects such as embedded graphics, equations etc. In stored segments. The program may automatically suggest unchanged “translations” for numeric data, for example, given the number “37” as a word in a sentence, the number “37” may be displayed as a suggested translation even if not stored in the database. This does preferably not prevent the user from providing an alternate or additional translation, such as “thirty-seven”, for this number, and, like other “words” in the sentence, numbers can also be selected for translation in any desired order. Any time a translation string containing a number is stored, a numeric wildcard may be stored with the string instead of the actual number. For example, If the user translates “Der Hund belite ununterbrochen für 7 Stunden” as “The dog barked 7 hours nonstop”, this may be stored in the database with a numeric wildcard in place of the value “7”, which is then automatically replaced with any new value in the suggested translation on reappearance of the same sentence with a different value in place of the 7. Accounting for the automatic storage of every possible linear concatenation of words in the sentence, on appearance of a new sentence, such as “Die Katze maunzte ununterbrochen für 2 Stunden”, the program should therefore preferably automatically suggest “2 hours nonstop” as a translation for “ununterbrochen für 2 Stunden” along with available translations for other portions of the source sentence.

As a user-selectable option, the program may also automatically suggest unchanged “translations” for data containing all uppercase letters, such as “SNOWBALL” or “KZ756” to account for product names or item numbers which are not changed on translation. As for numeric values, it should preferably be possible to select such words in any desired sequence for translation, and also to optionally store them in the database as wildcards, so if the user enters a translation of “Dies benötigt 500 ABC1” for “This requires 500 ABC1” and has the uppercase wildcard option selected, the program may automatically suggest the correct translation of “Dies benötigt 250 3XY5Z” for “This requires 250 3XY5Z”.

The program may store and retrieve individual words and phrases as well as syntactically linear concatenations of the same. By “linear”, what is meant is that the groups of words are stored only in the order in which they appear in the source text and where they can be logically assigned to complete translations. For example, if the user translates the text “Ich habe das schon getan” as “I have already done that”, proceeding one word at a time by selecting the words to be translated in the order in which they appear in the target sequence, the program may store, in addition to the translations for the individual words and for the entire sentence, entries for “Ich habe”, “schon getan”, “das schon getan”, but preferably not for “das habe Ich”, “Ich getan”, etc. Nor should it store entries for “Ich habe das” or “habe das schon” etc., as the sequence in which the user selected the words for translation does not allow the logical assignment of a translation to these groups even though they appear in sequence in the original.

Stored translations for multiple-word entries starting later in the source, e.g. for “schon getan” and “das schon getan” for the example above, may be displayed in the same way as multiple-word entries starting at the first word in the source, in this case “Ich habe”.

Again, if the user translates AA, then BB, then CC, all without stopping the program, the database should now contain translations for M, BB, CC, M BB, BB CC, and M BB CC. Not suggestions the tool compiles on the spot, actual db entries! Similarly, if there is a syntax change, i.e. M BB CC DD->cc dd aa bb, there should now be actual db entries for AA, BB, CC, DD, AA BB, CC DD, and M BB CC DD.

User-selectable use of wildcards to account for split verbs, such as in the sentence “Das hängt von seiner Entscheidung ab”, or “Die Kosten nehmen mit Behandlungszeit und Grösse des Projektes zu.” In these cases, “hängt . . . ab” can be stored in the database with the translation “depends”, or “nehmen . . . zu” with the translation “increase”.

The program may replace sources with formatting different from the surrounding text with targets in the same formatting. For example, if the user translates “Die”, “Katze” and “maunzt” one word at a time as “The”, “cat” and “meows” in the source sentence “Die Katze maunzt”, the resulting translation will read “The cat meows”.

As a user-selectable option, the program may provide ‘fuzzy’ detection of sources with variant spelling, spacing, punctuation, syntax, or ‘placeable’ inline numbers, graphics, equations etc. The degree of fuzzy source matching may be user-adjustable.

Separately from ‘fuzzy’ matching, the program may optionally account for singular/plural, verb forms and capitalization variants, checking for and offering translations for words with similar root forms and with or without capitalization or alternate endings. Provision may be made for supplying these endings, such as “s”, “n” or “en”, in a user-editable list.

As a user-selectable option, the program may leave unchanged or “translate” decimal separators such as “,” and “.” in the desired direction.

As a user-selectable option, the program may provide for background storage and extraction of data from translation work. The user can select to deactivate the pop-up display window and, with or without automatic insertion of translation memory markup tags in the working document, perform translation work “unaided” by overtyping the source document with the translation. If background processing is selected, the program may save each completed sentence detected by comparison with the original as a source/target translation pair in the database, and may further analyze the stored sentences based on current database contents to extract any new terminology from the new sentences. Optional automatic insertion of translation memory markup tags in the working document may be possible here as well.

For background storage, if a user translates “am” in the sentence “I am happy”, stops, then translates “I”, stops again and then translates “happy”, any human observer can look at the working document and see that the user has translated the entire sentence “I am happy”. Similarly, if the program observes that, initially, ActiveDocument.Sentences(x).Text=“I am happy”, and at some later time ActiveDocument.Sentences(x).Text=“Ich bin froh”, and further notes that there has been no other significant change to the document, and that the insertion point is no longer within that sentence, it should preferably thereupon store the translation memory pair “I am happy”=“Ich bin froh” with no further user input.

For background extraction, if the tool at some later point observes a similar change from “I am sad” to “Ich bin traurig” in ActiveDocument.Sentences(y).Text, the program should preferably then recognize and store “Ich bin” is a possible translation for “I am”, as well as, by simple process of elimination, storing “froh” for “happy” and “traurig” for “sad”. Furthermore, the tool may check the database for prior storage of the individual words in these sentences. If upon doing so, it detects the translation “ich” for “I”, it should by the same process of elimination store “bin” for “am”.

This process may be repeated, drawing upon all prior stored database entries, until each stored sentence has been broken down into the smallest translatable segments. All such computer-generated terminology/translation memory entries may be marked as such for user-selectable color-coding in the display to prevent confusion with confirmed human-entered translations.

In addition to background storage and terminology extraction, the program may also have a user-selectable “automatic suggestion” mode. This function may operate similarly to that of “autocompletion” programs, where the popup window with list of translations is automatically displayed only if the database contains a matching translation for a text string starting at the current insertion point in the working document. The user may be allowed to choose to accept the suggested translation, to edit or delete it as described above, or to press the Esc key and continue “unaided” translation work.

Provision may be made for selection of optional closing up of double blanks (whitespaces) inadvertently inserted by the source author or retention of all whitespaces. This function need only work when translating one word at a time; if a database hit is found, for example, by fuzzy matching of a source containing extraneous blank spaces, variant spellings, etc., the target may be inserted “as is” unless further edited by the user.

As a user-selectable option, once a phrase or sentence has been translated, provision may be made for processing to be stopped or for the tool to automatically continue processing at the next sentence, table cell or other translatable text in the working document.

Automatic scrolling of working document: On completion of a sentence or other element, with automatic continuation of processing, if the next text to be translated is not displayed on screen, the tool may optionally stop or may force the working document application to scroll the text into view before continuing processing.

The program may also be capable of recognizing industry standard translation memory markup tags (‘{0> . . . <}’ etc.) and taking appropriate action whether they are displayed or hidden. On encountering tagged translation pairs in a document where the source and target are identical (i.e. no prior translation has taken place) and translation memory markup tags are hidden in the display, processing as described here may be unchanged, but the user may have the option of using hotkeys to display the translation pairs for editing as they would appear in any “standard” translation memory program, with appropriate highlighting of the source and target. The tool's window with translation listings may then be displayed at the highlighted target for normal processing, but provision may be made for deactivation of this window for processing as in industry-standard translation memory programs. On completion of a sentence, tagged translation pairs may again be displayed in the working document as normal text with the source and tags hidden and the translation visible, and processing may continue to the next sentence.

If tagged translation pairs are encountered in a document where the source and target are not identical (i.e. the document has been pretranslated) and translation memory markup tags are hidden in the display, the program may automatically display these pairs for editing as they would appear in any “standard” translation memory program, with appropriate highlighting. For translation memory pairs which have already been translated and only require checking or minor corrections, provision may be made for the user to use hot keys to optionally deactivate the program's normal listing and highlighting functions (if activated) and to edit and accept the translation pairs. On completion of a sentence, tagged translation pairs may again be displayed as normal text with the source and tags hidden and the translation visible, and processing may continue to the next sentence.

Provision may be made for the user selecting optional markup of a document using industry-standard tags. If this option is selected, each time translation of a sentence is completed, the complete source and target sentences may be automatically marked and stored in the document.

Preferably, none of these options should affect the program's storage of translation pairs in the database, although if only entire sentences are edited and accepted, database storage can be limited to the entire sentences as translation pairs.

The program may provide for backup and filterable import/export and merging of database information in a variety of formats, including industry-standard TMX format and CSV format as a minimum. A progress bar should preferably be included to inform the user of import/export status.

The program may provide for automated or semiautomated processing of translation feedback or corrections in the database, including making changes to translation database entries with the same terminology but not used in the corrected translation, with automated or semiautomated storage of time stamp and reference information for each entry. For example, if the user opens a previously translated document containing corrections, he may be able to select a menu option for either automatic replacement or supplementing all of the database entries corresponding to changes in the document. This may be done by comparison of all previous target entries for the original document (as determined by document information stored with entries, see above) with corresponding text strings in the new document and replacement of the existing entries or inclusion of the revised entries, with new time stamp and any additional user-supplied information. As a further option, provision may also be made for replacement or supplementing of all database entries with corresponding terminology change requirements.

For example, if the user has previously translated “Die Küche war hervorragend” as “The kitchen was protruding” and receives the translated document back from a customer with the correction “The cuisine was outstanding”, and depending on which option the user selects, the tool may either replace the database entries for “Die Küche war hervorragend”, “Die Küche war”, “Die Küche”, “Küche war hervorragend”, “Küche war”, “Küche”, “war hervorragend” and “hervorragend” with the corresponding corrections, or may supplement the database with additional targets for these source entries, including time stamp and (for example) customer information, and, as a further option, may also replace or supplement all other entries in the entire database containing the words “Küche” or “hervorragend”. The user may have the option of examining these entries one at a time for approval of changes or supplements or having the tool automatically process all corresponding entries for the working document.

If selected as an option, the program may also regularly examine selected directories on the user's computer for updates to previously processed documents and may prompt the user for automatic processing of any corrections as described above.

The program may also include a separate mask which can be called up from a menu for creating, searching, editing and deleting database entries, including automated or semiautomated processing of similar entries. It may be possible to search for entries in both the source and target languages as well as using filters for information stored with the entries.

### Additional Features:

Fast processing mode—as a user-selectable option if there is only one database entry for a word or phrase (in each case the longest available concatenation of words is taken), the program may automatically insert the corresponding entry and proceed to the next word or phrase.

By default, processing of the working document may be started by pressing the Ctri-Space keys. Provision may also be made for user configuration of an additional or alternate key combination.

Provision may also be made for optional startup of translation processing and list display when the user leaves the insertion point at the same location for a user-selectable delay period, such as 500 ms.

To enable research work in mid-sentence, provision may be made for pausing processing without exiting (window remains active) by pressing a hotkey.

The user may be able to list which applications the program interacts with; the default is Microsoft Word only.

Provision may be made for calling up a separate program mask with a list of ‘new’ vocabulary terms in the working document which are not found in the database. It may then be possible to export this list in text file format as a minimum for further processing.

User-configurable popup context-sensitive menus/help: on pressing the Alt key, the program may first accept input from a second hotkey to perform a desired action (such as Alt-right arrow to extend the selected sentence). If a second key is not pressed within a user-configurable delay period, the program may display a user-selectable list of actions most frequently used, followed by the full list of possible actions after a second user-selectable delay time.

A basic menu for user-selectable options/help should preferably also be displayed by right-clicking anywhere in the list box.

Filtering of database hits—Provision may be made for the definition and application of filters for time stamp, subject and/or customer information associated with database entries. For example, if a translator routinely does work for two different customers, one requiring translation of “Küche” as “kitchen” and the other requiring “cuisine”, the user may be able to filter out the undesired entries. Provision may be made for either hiding filtered entries or displaying them in an alternate color.

As a user-selectable option, provision may also be made for color coding of list entries, such as for unsubstantiated or confirmed terminology, or entries generated by the tool from statistical parsing of previous translation work.

User-selectable option of automatic capitalization at the start of each line or sentence, as well as automatic capitalization at the start of each table cell. These could presumably also be based on the settings of Application.AutoCorrect.CorrectSentenceCaps and CorrectTableCells in Word. Optional selection of automatic detection and capitalization of titles and section headings should preferably be provided for; this may depend to some extent on “Style” selection in Word, if Word is used as a text processing system.

As a user option, the program may attempt to account for mixed formatting in concatenated entries. For example, given the source sentence “Die Katze maunzt”, even if the translation “The cat meows” already exists in the database, the program may look for a translation of the individual word “Katze”, and, if found, use this in combination with the full-sentence translation to compose a suggestion with the appropriate formatting, in this case, “The cat meows”.

Compilation of usage statistics: The program may keep track of which navigation keys the user presses, and how many times, for each selection, as well as how far down from the top of a list the final selection appeared. The number of times database entries are selected, modified, or new entries added may also be recorded. This information may be provided to the user in a table called up in the menu, enabling further optimization of the interface by making changes to personal options for the display order or navigation keys.

The database may be used to store entries in a single source-target direction, but provision may be made for bidirectional usage as well as for multiple-language entries and use (e.g. English-to-German, English-to-French, German-to-French, all in one database).

As a user-selectable option, the program may also provide a simple autotype/autocompletion function, drawing on the database, for use such as when editing a document or creating a new database entry.

As a user-selectable option, the program may provide for on-the-fly spell checking of target entries before acceptance for insertion in the working document and storage in the database. This necessitates the installation of a dictionary in the target language.

As a user-selectable option, the program may provide for semiautomated project processing. If selected, and when a user starts working with a new document for the first time, the program may prompt the user for project, customer and subject information for storage with each database entry associated with this document.

The program may include standard copy-protection and registration features.

Provision may be made for database encryption if required.

A dash can be both a separator and part of a word, such as in “Mauskugel und-Taste” or “Maus-Taste”. So can a slash, and a period in an abbreviation, and, in the case of German, so can letters like e, n, s, en, and es. Likewise, periods should preferably be treated as either sentence terminators to be left untouched or as decimal points or abbreviation marks past which the sentence should be extended, either by detection of an existing abbreviation or by user command. The specific rules are left up to the programmer, but the user may be able to list these special-treatment characters himself for the specific source language. These characters should preferably then be handled as simply as possible, either as separate words or as connected to words, without actually trying to develop any grammatical rules or otherwise delving into machine translation.

A simple set of rules for handling of commas; the same or a similar set of rules may be applied to hyphens, semicolons etc.:

a. First, it should be understood that in some cases a sentence containing a comma may be translated with one not containing a comma, and vice versa, or that a comma appearing after one word in a source text may be positioned elsewhere in the target translation, and finally that a comma may appear as a decimal separator (and a period as a thousands separator) in some languages and will also have to be ‘translated’.

b. Second, in some cases, a word followed by a comma may be translated by a word without a comma, and vice versa, and syntax changes may also be involved. For example, the word “jedoch” in the middle of a German sentence is often mapped to the word “However,” at the start of an English sentence.

c. The user may therefore have the option of selecting a comma and “translating” it as nothing, or as a comma, selecting a word or phrase followed by a comma and translating that with or without a comma, selecting a word or phrase and translating with a trailing comma if need be, or, if possible, inserting a comma immediately after the last word without stopping the program or moving the insertion point by simply pressing a hotkey such as Alt-, and having this also stored in the db as part of the “recorded” translation.

d. The tool should preferably also successfully “translate” decimal numbers based on user selections in the options menu. Note that some continental authors also mix decimal separators within the same document.

A hyphen can appear in a word or phrase as:

1) a connector between phrases—like this;
2) a wildcard for part of a combined word: pre- and posttesting.
(literal translation from German; actual translations could be “pre and post-testing” or pretesting and post-testing”).
3) a part of a combined word: post-testing, post-testing, post-testing (depending on who is doing the writing).
4) an operator or minus sign: 1−2=−1.

The “translation” for the hyphen may account for each of these as follows:

1)“−”, treated as a word, i.e. with spaces fore and aft.
2)“ ”, treated as part of the word to which it is attached.
3) “ ”, treated as a space between the two translated words, or possibly as 1) “-”, depending on the target language.
4) “-”, in the first instance as a word with spaces, in the second as either glued to the number or followed by a space, depending on preference.

1. A computer-implemented translation tool, comprising:
a database module capable of storing, in a database, a plurality of source words expressed in a source language and corresponding target words expressed in a target language;
a concatenation module for generating source concatenations of said words expressed in the source language and corresponding target concatenations of said words expressed in the target language, and for storing said concatenations in the database;
an input module for receiving a source text in said source language;
a translation module programmed to, upon occurrence of a predefined event, search the database for a match between a word or a sequence of words of the source text and said source words or said source concatenations, and to propose at least one translation of said word or sequence into the target language in case of a found match, the at least one translation being provided as that one or those of the target words or the target concatenations, which corresponds to the matching source word or source concatenation.

2. The translation tool of claim 1, wherein the translation module is programmed to interact with a text processing program operated by a user of the translation tool, the translation module being further programmed to enter a user-selected one of the at least one translation into a working document in the text processing program.

3. The translation tool of claim 2, wherein the translation module is programmed to present the at least one proposed translation to the user in an interface in the text processing program.

4. The translation tool of claim 3, wherein said interface contains a list of source words or sequences of source words and corresponding target words or sequences of target words.

5. The translation tool of claim 3, wherein said interface contains a list of target words or sequences of target words corresponding to a word or a sequence of words highlighted in the text processing program.

6. The translation tool of claim 2, wherein the translation module is programmed to show a plurality of lists of possible translations of words of the source text in the text processing program, there being provided one list adjacent each word in the source text.

7. The translation tool of claim 1, wherein the translation module is further programmed to:
decompose said sequence of words of the source text into a plurality of sub-sequences;
search the database for matches between each of the sub-sequences and source concatenations of the database;
propose a sub-translation in respect of each sub-sequence, each sub-translation being provided as the target concatenation corresponding to the matching source concatenation.

8. The translation tool of claim 7, wherein the said sub-sequences constitute different linear concatenations of individual words of said sequence of words of the source text, whereby the sub-sequences include different numbers of words.

9. The translation tool of claim 7, wherein the translation module presents the sub-translations in a prioritized order to a user of the translation tool according to at least one of:
length of the subsequences;
most frequently selected sub-translation;
order of appearance in the source text.

10. The translation tool of claim 7, wherein the translation module is further programmed to:
decompose said sequence of words of the source text into a plurality of words;
search the database for matches between each of the words of said sequence and source words stored in the database;
propose a translation of each word of the sequence, the translation being provided as the target word which corresponds to the matching source word.

11. The translation tool of claim 1, wherein the translation module is programmed to recognize a user interaction as said predefined event.

12. The translation tool of claim 1, wherein the translation module is programmed to interact with a text processing program including a user-operable insertion marker and to recognize, as said predefined event, the presence of the insertion marker at a single location in the source text for a predetermined period of time.

13. The translation tool of claim 1, wherein the translation module is programmed to automatically generate concatenations of words of the source text and to search the database for matches between said sequences and said source concatenations.

14. The translation tool of claim 1, wherein the concatenation module is programmed to generate a plurality of target concatenations of the concatenations of the database.

15. The translation tool of claim 1, wherein the translation module is further programmed to receive user-provided translations of sequences of the source text and to store, in the database, all possible linear concatenations of the words and sub-sequences in the user-provided translations in the source language and in the target language.

16. The translation tool of claim 14, wherein the translation module is further programmed to recognize a change of syntax between the sequence of words of the source text and the target concatenations, and to store, in the database, a target concatenation of words, which corresponds to the changed syntax of the source text.

17. The translation tool of claim 1, wherein the translation module is further programmed to:
decompose the sequence of words of the source text into a plurality of sub-sequences; and
in case no sub-translation of one of said sub-sequences is found as a target concatenation
in the database: split at least one of the sub-sequences into a first and a second fragment, and to search the database for target concatenations matching said fragments; and
in case the fragments match concatenations or words in the target language: concatenate the corresponding target fragments into a new database entry.

18. The translation tool of claim 17, wherein the steps of decomposing, splitting, concatenating and storing are performed without user interaction.

19. The translation tool of claim 1, wherein the translation module is programmed to activate a dictionary-look-up module following pre-defined user-interaction, allowing retrieval of translations of words or phrases of source text into the target language.

20. The translation tool of claim 1, wherein the translation module is programmed to recognize a word or plurality of words of the source text as an initial fragment of a concatenation of words stored in the database and to autocomplete a translation of said concatenation into the target language.

21. The translation tool of claim 1, wherein the translation module is programmed to, upon translation of a text string into the target language by the translation module, allow user-Initiated corrections to the text string of the target language, and to store said corrections in the database.

22. The translation tool of claim 1, wherein the database is capable of storing a plurality of target words or target concatenations matching one source word or one source concatenation, and wherein the translation module is programmed to propose a plurality of translations in respect of one single source word or source concatenation, the translation module being further programmed to list said plurality of translations according to their frequency of use.

23. The translation tool of claim 1, wherein said predefined event includes user-initiated highlighting of a word or a sequence of words of the source text.

24. The translation tool of claim 1, wherein the translation module is programmed to interact with a text processing program operated by a user of the translation tool wherein the translation module is further programmed to perform background markup of a working document of the text processing program with translation memory tags.

25. The translation tool of claim 1, wherein the translation module is programmed to interact with a text processing program operated by a user of the translation tool wherein the translation module is further programmed to store in the database words or sequences of words manually translated by the user and typed in the text processing program.

26. The translation tool of claim 1, wherein the translation module includes a user-correction interface allowing a user of the translation tool to correct the translations stored in the database.

27. The translation tool of claim 26, wherein the translation module is programmed to store corrections as new database entries without deleting previous entries.

28. The translation tool of claim 26, wherein the translation module is programmed, on detection of the user having opened in a text processing program a document containing corrections or changes to a previous translation for which entries were stored in the database, to sequentially display each such correction to the user for approval and to store said changes in the database.

29. The translation tool of claim 28, wherein the translation module is programmed to perform said storage of said changes in the database without user approval of each individual change.

30. The translation tool of claim 28, wherein said changes to database entries include changes to database entries containing elements not stored during translation of the original of said document but for which said document contains corrections or changes.

31. The translation tool of claim 1, wherein the translation module is programmed to search a file system of the computer, onto which the tool is installed, for documents containing corrected translations or translations not stored in the database, and to store said translations in the database.

32. The translation tool of claim 31, wherein the translation module is programmed to store said corrected translations or translations not stored in the database as new database entries without deleting previous entries.

33. The translation tool of claim 32, wherein the translation module is programmed, on detection of a document containing corrections or changes to a previous translation for which entries were stored in the database, to sequentially display each such correction to the user for approval and to store said changes in the database.

34. The translation tool of claim 33, wherein the translation module is programmed to perform said storage of said changes in the database without user approval of each individual change.

35. The translation tool of claim 33, wherein said changes to database entries include changes to database entries containing elements not stored during translation of the original of said document but for which said document contains corrections or changes.

36. The translation tool of claim 1, wherein the translation module is programmed to automatically analyze the database contents to extract additional, smaller translation segment pairs by comparison of existing elements and to store said elements as new database entries or as supplemental translations for existing database entries.
